(19) United States
(12) Patent Application Publication
(10) Pub. No.: US 2015/0345130 A1
(43) Pub. Date: Dec. 3, 2015

(54) VENTILATION LOUVER

(71) Applicants: Howard Worthing, Marble Falls, TX (US); Carl Hackney, Round Rock, TX (US)

(72) Inventors: Howard Worthing, Marble Falls, TX (US); Carl Hackney, Round Rock, TX (US)

(21) Appl. No.: 14/702,761

(22) Filed: May 4, 2015

Related U.S. Application Data
(60) Provisional application No. 62/004,818, filed on May 29, 2014.

(51) Int. Cl. E04B 1/70; E06B 7/08; E06B 7/082; F24F 13/06; E06B 7/10

(52) U.S. Cl. CPC E04B 1/7076; F24F 13/06; E06B 7/10; E06B 7/082; E06B 7/08; E04B 1/7069

(57) ABSTRACT

Accordingly, a ventilation apparatus includes a frame having a plurality of angled slots formed in adjacent members of the frame, the adjacent members being interconnected to form a continuous peripheral surface. A plurality of adjacent translucent louver members each have terminal ends, the terminal ends being inserted into at least two of the adjacent members of the frame. Each louver member is formed of an elongated strip of a synthetic material being bent at an angle matching the angled slots, whereby the terminal ends of each strip are angled to engage with the angled slots formed in opposite ones of the adjacent members of the frame.

### CROSS REFERENCE TO RELATED APPLICATIONS

This application is related to and claims priority to U.S. Provisional Application No. 62/004,818, filed May 29, 2014, which is incorporated by reference herein in it's entirety.

### BACKGROUND

This disclosure relates generally to public access buildings and more particularly to buildings including public bathroom facilities and sufficient ventilation louvers for use in such buildings.

The present disclosure was conceived in response to a growing need to provide sufficient ventilation and natural light for public access buildings which include bathroom facilities, such as those buildings provided in parks, roadside rest areas and other facilities. Such buildings may also include storage areas and concession areas but ventilation of the bathroom facilities is of primary concern. Natural light is often provided by the use of skylights, which are prone to vandalism and will eventually leak.

Ventilation is often provided in the form of louvered openings or screened openings usually in a gable area of a building. These openings assist in the ingress and egress of air thus promoting constant air circulation and cooling in the warmer weather. However, the openings also must provide substantial protection from wind, rain, insects, birds and security, e.g. breaking and entering or other unauthorized access to the restroom. Also, there must also be protection from unwanted privacy invasions such as by “peeping Toms”.

The openings are sometimes only covered by a screen or mesh and may be effective against insects but offer no privacy. Also, insects can often clog such screened openings and offer little resistance to rain. Louvers have also been used either alone or in combination with a screen or mesh and can protect against rain and improve privacy but are often made with unsuitable materials. For example, metal louvers may rust or corrode, as will metal or mesh screens. The louver members may often be easily broken when formed of wooden or synthetic slats. Also, the frame of the louver which supports the slats may be of wood or synthetic material and may require maintenance such as painting, or replacement from time-to-time when broken.

It would be of benefit to provide louvered openings which are durable enough to resist breaking or tampering, resist blowing rain, permit light entry, enhance privacy and security, require little or no maintenance, resist corrosion and provide adequate ventilation.

### SUMMARY

Accordingly, a ventilation apparatus includes a frame having a plurality of angled slots formed in adjacent members of the frame, the adjacent members being interconnected to form a continuous peripheral surface. A plurality of adjacent translucent louver members each have terminal ends, the terminal ends being inserted into at least two of the adjacent members of the frame. Each louver member is formed of an elongated strip of a synthetic material being bent at an angle matching the angled slots, whereby the terminal ends of each strip are angled to engage with the angled slots formed in opposite ones of the adjacent members of the frame.

### BRIEF DESCRIPTION OF THE DRAWINGS

FIG. 1 is a perspective view illustrating an embodiment of a public restroom facility including ventilation louvers provided in a gable portion of the facility.

FIG. 2 is a frontal view illustrating an embodiment of a ventilation apparatus for use in the facility of FIG. 1.

FIG. 3 is a perspective view of the apparatus of FIG. 2.

FIG. 4 is another perspective view taken along the line 4-4 of FIG. 3.

FIG. 5 is an end view of a partial frame member including chevron shaped slots.

FIG. 6 is a perspective view illustrating an embodiment of a louver.

### DETAILED DESCRIPTION

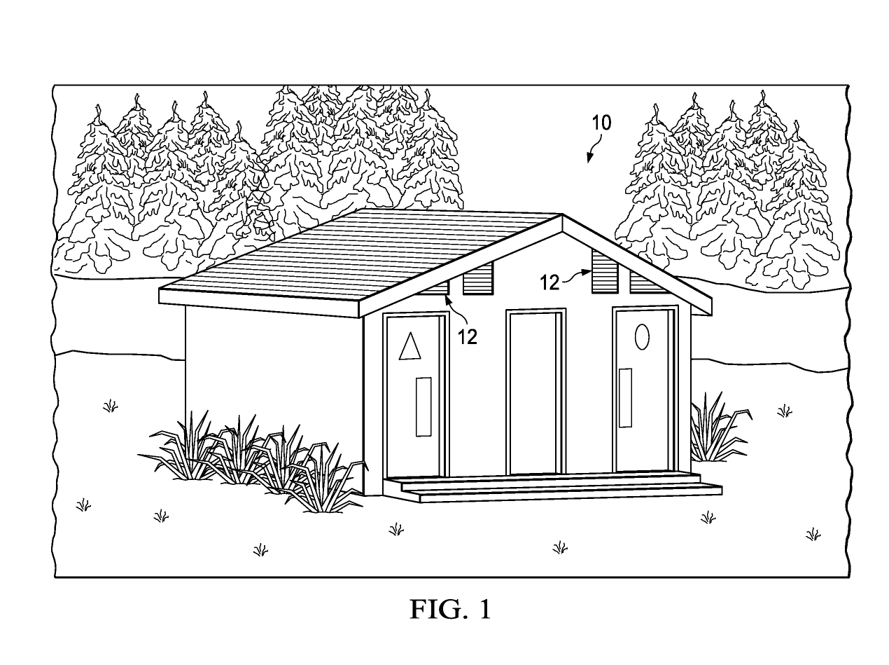

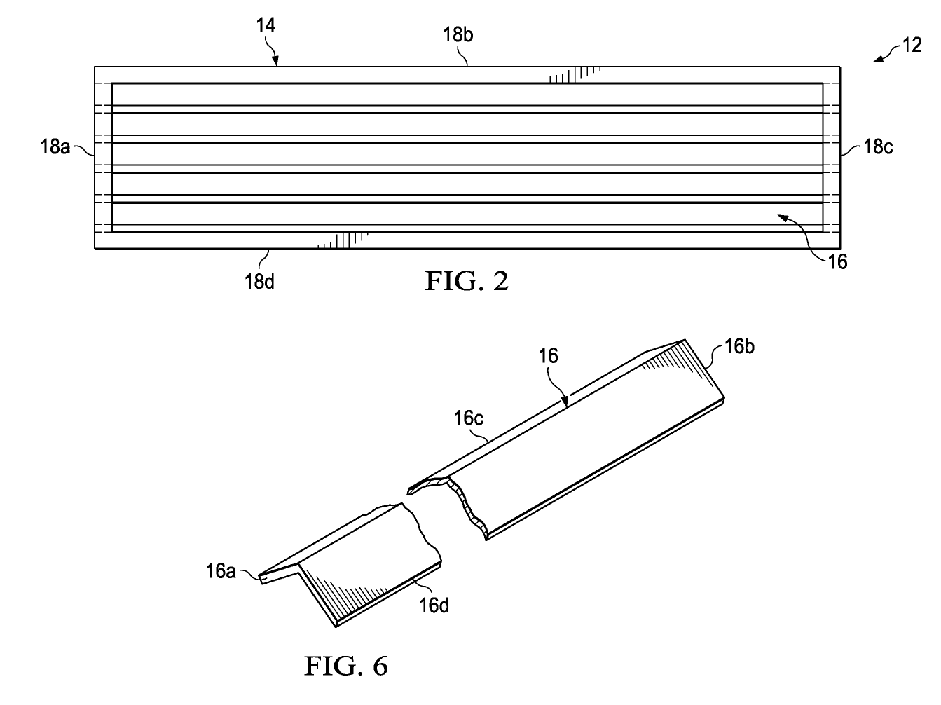

In FIG. 1, a public access restroom 10 is illustrated. The restroom 10 includes a ventilation apparatus 12, which provides a protected passage of fresh air. The apparatus 12, FIG. 2, may be of any desired geometric shape but requires a peripheral frame 14 and a plurality of louvers 16. The shape could be a square, rectangle, triangle, etc., and that shape is dictated by the frame 14. In FIG. 2, the frame 14 is a rectangle comprised of a plurality of suitable interconnected adjacent frame or enclosure members 18a-d thus forming a continuous peripheral enclosure. Certain frame members, e.g. 18a, 18c are opposite one another.

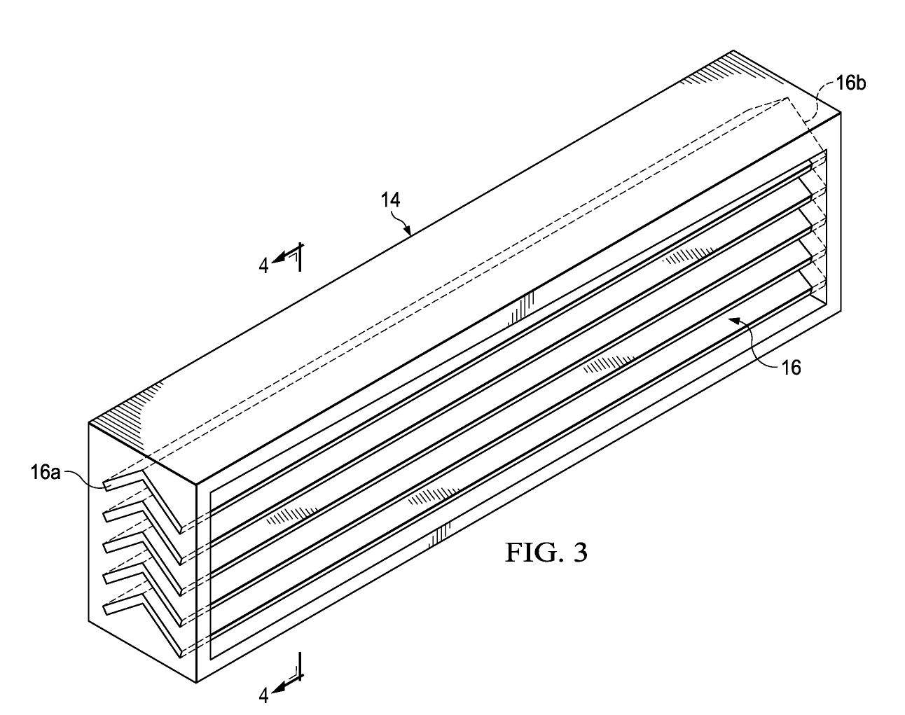

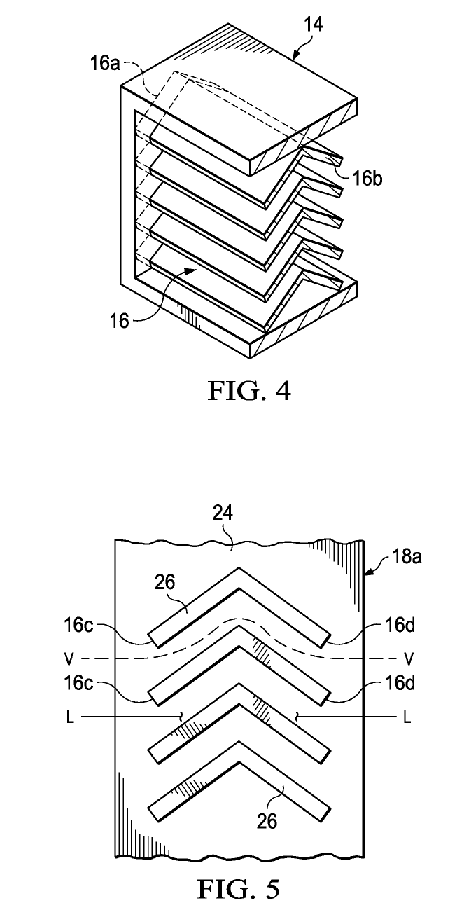

The plurality of louver members 16, FIGS. 2-4, each of which includes a pair of terminal ends 16a, 16b, are mounted in frame 14 in parallel to each other louver member 16. Each louver member 16 is an elongated strip of a synthetic material, which is bent to a chevron shape at an angle of about 90°, see FIGS. 4 and 6.

FIG. 5 illustrates that one of the frame members 18a, partially shown, has an interior surface 24 including a plurality of stacked angled slots 26. Another one of the members, for example member 18c, FIG. 2, would include another plurality of stacked angled slots 26, similar to the slots illustrated in FIG. 5. Each louver 16, see FIGS. 3 and 4, has the pair of opposed terminal ends 16a, 16b, which are angled to match the angled slots 26. Thus, the louvers 16 at terminal ends 16a, 16b are mounted in and supported by slots 26 in a parallel-stacked array as mentioned above and illustrated in FIGS. 2-4.

The preferred material for the frame members 18a-d is a high density polyethylene (HDPE). The preferred material for the louvers 16 is a high impact synthetic material such as that sold under the Trademark LEXAN®, and the louvers 16 are preferably translucent to permit light into the facility 10 while providing a strong, private, ventilated barrier which also protects against wind, blowing rain and vandalism. Preferably, the frame members will have about a one-inch thickness and the louvers will have about a one-quarter inch thickness

From the foregoing, it can be seen in FIGS. 1-6, that a frame 14 of any desired geometric shape, is formed of adjacent frame members 18a-d, interconnected to form a continuous peripheral enclosure. It is understood that frame 14 could be a unitary member, however, fabrication of a plurality of interconnected members is preferred. An interior surface 24 of opposed frame members, e.g. 18a and 18c, includes angled slots 26, arranged in a vertically aligned orientation having an illustrated V-shape of each slot 26 such as an inverted chevron.

A plurality of adjacent, translucent louver members 16 each include opposite ends 16a, 16b. Surfaces 16c and 16d, of each louver member 16, FIG. 5, are positioned to overlap like surfaces of each adjacent louver member, whereby a line-of-sight, L, through the stacked spaced apart louvers is blocked, and ventilation, V, through the louvers is unblocked. The toughness of the material, i.e. LEXAN®, used to form the louvers 16, helps resist tampering and breakage. The opposite ends 16a, 16b of each louver are inserted into respective slots 26 in opposed frame members 18a and 18c, for example. The louvers 16 span the frame horizontally for best results in rejecting blowing rain due to the inverted chevron orientation.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A ventilation apparatus comprising:
a frame having a plurality of angled slots formed in adjacent members of the frame, the adjacent frame members being interconnected to form a continuous peripheral enclosure;
a plurality of adjacent translucent louver members each having terminal ends, the terminal ends being inserted into at least two of the adjacent members of the frame; and
each louver member being an elongated strip of a synthetic material being bent at an angle matching the angled slots, whereby the terminal ends of each strip are angled to engage with the angled slots formed in opposite ones of the adjacent members of the frame.

2. The apparatus of claim 1 wherein the frame is formed of high density polyethylene (HDPE).

3. The apparatus of claim 2 wherein the louvers are formed of LEXAN®.

4. The apparatus of claim 1 wherein the slots are in a vertically aligned orientation.

5. The apparatus of claim 4 wherein the louver members are V-shaped.

6. The apparatus of claim 5 wherein the louver members are in a stacked array.

7. The apparatus of claim 1 wherein the louver members span the enclosure horizontally.

8. A ventilation apparatus comprising:
a frame having a plurality of angled slots formed in adjacent members of the frame, the adjacent frame members being interconnected to form a continuous peripheral enclosure, the slots being aligned in an inverted chevron pattern;
a plurality of adjacent translucent louver members each having terminal ends, the terminal ends being inserted into at least two of the adjacent members of the frame, the louvers spanning the enclosure in a stacked, spaced apart array; and
each louver member being an elongated strip of a synthetic material being bent at an angle matching the angled slots, whereby the terminal ends of each strip are angled to engage with the angled slots formed in opposite ones of the adjacent members of the frame.

9. The apparatus of claim 8 wherein the frame is formed on high density polyethylene (HDPE).

10. The apparatus of claim 9 wherein the louvers are formed of LEXAN®.

11. The apparatus of claim 8 wherein the slots are in a vertically aligned orientation.

12. The apparatus of claim 11 wherein the louver members are V-shaped.

13. The apparatus of claim 12 wherein the louver members span the enclosure horizontally.

14. The apparatus of claim 12 wherein surfaces of each V-shaped louver member overlap the V-shaped surfaces of each adjacent louver member, whereby a line-of-sight through the stacked louvers is blocked and ventilation through the stacked louvers is unblocked.

15. A method comprising:
providing a frame having a plurality of angled slots formed in adjacent members of the frame, the adjacent frame members being interconnected to form a continuous peripheral enclosure of a selected geometric shape, the slots being in a vertically aligned orientation in an inverted chevron pattern;
providing a plurality of adjacent, translucent louver members each having terminal opposite ends, the terminal ends being inserted into at least two of the adjacent members of the frame, the louvers spanning the enclosure horizontally in a stacked, spaced apart array; and
forming each louver member of an elongated strip of a synthetic material and being bent at an angle matching the angled slots, whereby the terminal ends of each louver are angled to engage with the angled slots in opposite ones of the adjacent members of the frame.

16. The method of claim 15 wherein the frame is formed of high-density polyethylene (HDPE).

17. The method of claim 16 wherein the louvers are formed of LEXAN®.

18. The method of claim 15, wherein the louver members are V-shaped.

19. The method of claim 15, wherein the louvers admit light and resist tampering.

20. The method of claim 15, further comprising:
positioning surfaces of each V-shaped louver member to overlap the V-shaped surfaces of each adjacent louver member, whereby a line-of-sight through the stacked louvers is blocked and ventilation through the stacked louvers is unblocked.
